(19) United States
(12) Patent Application Publication
(10) Pub. No.: US 2015/0043999 A1
(43) Pub. Date: Feb. 12, 2015

(54) PUSH RING DEVICE AND COIL BONDING MACHINE

(71) Applicant: Qingdao H. Y. Corporation, Qingdao (CN)

(72) Inventor: Yang YU, Qingdao (CN)

(21) Appl. No.: 14/524,504

(22) Filed: Oct. 27, 2014

Related U.S. Application Data
(63) Continuation of application No. PCT/CN2013/082914, filed on Sep. 4, 2013.

(30) Foreign Application Priority Data
Nov. 28, 2012 (CN) 201210493627.6

(51) Int. Cl. B42B 5/10

(52) U.S. Cl. CPC B42B 5/103
USPC 412/39

(57) ABSTRACT

A push ring mechanism includes a push ring transmission mechanism; a push board; a coil positioning mechanism; the coil positioning mechanism comprises a fixed board and an adjustable limiting board; the limiting board includes a first bracket which extends through a longitudinal hole on the fixed board; the adjustable limiting board is arranged parallel to the fixed board, such that the plug-in plate containing coils can be inserted between the limiting board and the fixed board; a hook for holding a coil is in front of the limiting board; an adjustment mechanism is provided for adjusting the limiting board; a transmission mechanism includes a gear, and the gear is engaged with a gear rack.

### RELATED APPLICATIONS

The present application is a bypass continuation of International Application No. PCT/CN2013/082914, which claims the priority of CN Application No. 2012104936276, filed on Nov. 28, 2012. The entire contents of International Application No. PCT/CN2013/082914 and CN Application No. 2012104936276 are incorporated herein by reference.

### TECHNICAL FIELD

This invention relates to an office machine for binding papers with a coil, and specifically, it relates to a push ring device and a coil pressing machine.

### BACKGROUND

Known coil pressing machines used in domestic offices take a binding coil from a coil stationary box, and attach it to a bundle of papers that already have been punched, then press it manually or electrically. Most foreign machines also adopt this binding method. However, German RENZ has a machine, which can automatically take coils, and press files electrically, but this machine requires special packing of a dual coil, which occupies much space, with low efficiency and high cost. Therefore, an automatic ring-picking binding machine suitable for our coil stationary box is needed, however, such a device is not available in the market.

### SUMMARY

The present invention overcomes the above defects, and features a push ring device and a coil pressing machine that uses a plug-in plate type coil to bind files. A push ring device comprises a push ring transmission mechanism; a push board; a coil positioning mechanism arranged in front of the push board, wherein a plug-in plate with coils can be inserted into the coil positioning mechanism, and a space for a coil to penetrate is arranged below the coil positioning mechanism; the coil positioning mechanism comprises a fixed board and an adjustable limiting board, wherein a portion of the machine casing is the fixed board; the limiting board includes a first bracket which extends through a longitudinal hole on the fixed board; the adjustable limiting board is arranged parallel to and spaced from the fixed board, such that the plug-in plate containing coils can be inserted into the space between the limiting board and the fixed board; a hook for holding a coil is arranged in front of the limiting board; a limiting board adjustment mechanism is provided for adjusting the limiting board up and down and back and forth, the limiting board adjustment mechanism includes an up and down adjustment unit, a back and forth adjustment unit, and an adjustment button; the adjustment button is fixed and connected with a gear as a transmission mechanism, and the gear is engaged with a gear rack on a second bracket to realize the up and down adjustment; a fixed stop is included, which is set as a smooth transitional step, behind the second bracket is a gear lever, which contacts the fixed stop, when adjusted up and down, the step of the fixed stop enables the bracket to move back and forth. A coil positioning mechanism comprises a fixed board and a limiting board. The fixed board is part of the machine casing. The limiting board is adjustable and is arranged parallel to and spaced from the fixed board, such that a plate containing coils can be inserted into the space between the limiting board and the fixed board; a pushing board arranged below the limiting board and the fixed board so as to move transversely to the limiting board and the fixed board in a gap between lower edges of the limiting board and the fixed board; a motor arranged within the casing for driving the pushing board horizontally into the gap; an adjustment mechanism for adjusting the limiting board up and down to adjust the gap between the lower edges of the limiting board and the fixed board, and for moving the limiting board back and forth for adjusting the space between the limiting board and the fixed board; and a hook for holding a coil arranged in a front of the limiting board; wherein the gap and spacing can be adjusted to accommodate different size coils.

### BRIEF DESCRIPTION OF THE DRAWINGS

FIG. 1 is a structural diagram of a coil pressing machine according to one embodiment of the present invention;

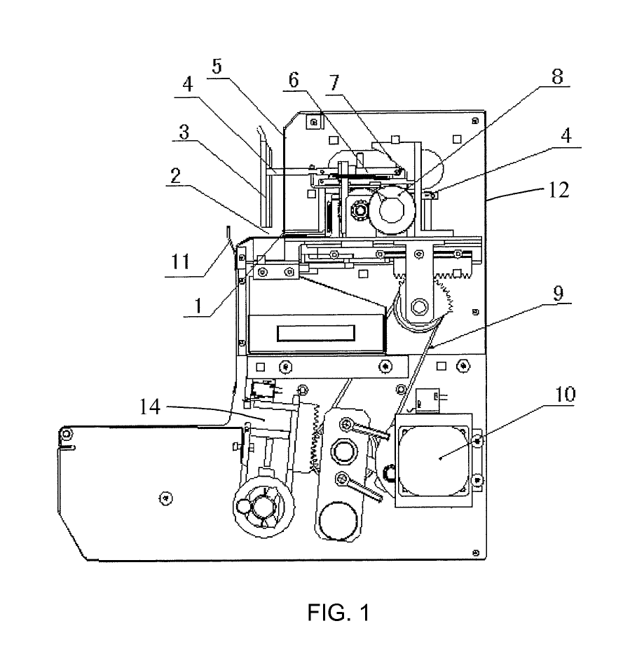

FIG. 2 is a structural diagram of the parts behind the coil pressing machine;

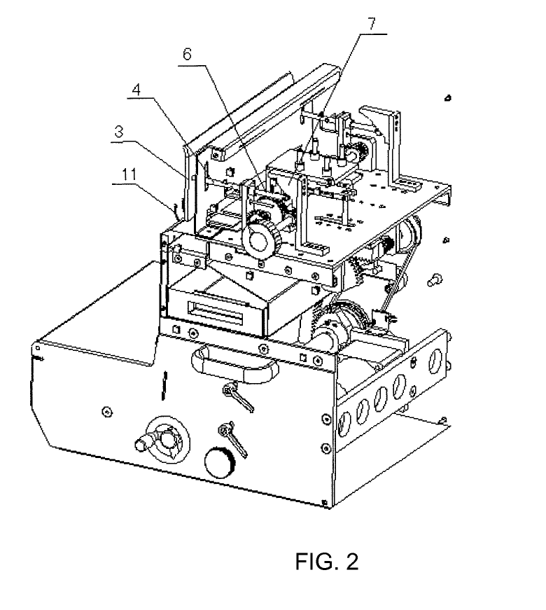

FIG. 3 is a view of a conventional coil for use in the present invention.

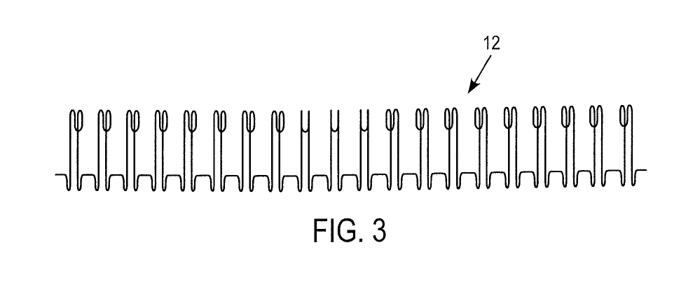

1-push board, 2-the space that coil penetrates, 3-limiting board, 4-bracket, 5-fixed board 5, 6-gear lever, 7-fixing stop, 8-button, 9-transmission mechanism, 10-motor, 11-hook, 12-coil.

### DETAILED DESCRIPTION OF A PREFERRED EMBODIMENT

The coil pressing machine comprises a machine casing, a push ring device, a power device 10, a transmission device 9 and a binding device, all of which are arranged in the machine casing. The power device 10 is a motor, the transmission device 9 transmits power of the power device to the push ring device and the binding device.

The push ring device comprises a push ring transmission mechanism and a push ring mechanism, the push ring transmission mechanism is connected with the transmission device.

The transmission device comprises a transmission shaft, and the push ring mechanism comprises a push board 1. A coil positioning mechanism is arranged in front of the push board 1, and a plug-in plate with coils 12 can be inserted into the coil positioning mechanism, and a space 2 for a coil 12 to penetrate through is arranged below the coil positioning mechanism.

The coil positioning mechanism comprises two positioning plates, one is a fixed board 5, the other is a limiting board 3 that is set in front of the fixed board 5. A limiting board adjustment mechanism is provided for adjusting the limiting board 3 up and down and back and forth. The space between the limiting board 3 and the fixed board 5 is matched with the coil. A coil hook 11 is arranged in front of a limiting board.

The limiting board adjustment mechanism includes an up and down adjustment unit and back and forth adjustment unit. An adjustment button 8 is included, and is fixed and connected with a gear (as the transmission mechanism), and the gear is engaged with a gear rack on a bracket 4 to realize up and down adjustment. A fixed stop 7 is also included, which is set as a smooth transitional step, and behind the bracket 4 is a gear lever 6, which contacts the fixed stop 7, when adjusted up and down, the step of the stop enables the bracket 4 to move back and forth.

The push board 1 is a plate that moves horizontally and extends transversely to the positioning plates 3, 5. The push board 1 includes a groove matching the coil positioning mechanism.

The bracket 4 of the limiting board 3 penetrates a longitudinal hole on the fixed board 5.

The limiting board 3 is a transparent board or hollow board to enable monitoring the coil 12 status.

The push ring transmission mechanism is a synchronous belt, and the synchronous belt is connected with a transmission shaft, and the synchronous belt transmits the power of the transmission shaft to the push ring mechanism.

The portion of the machine casing behind the limiting board is parallel to the limiting board, and is the fixed board 5.

When the machine is started, the motor 10 runs, so does the transmission shaft, then the synchronous belt transmits the power to the push board 1, and the push board 1 moves forward to push one of the coils 12 mounted on the plug-in plate, causing the coil 12 to be disconnected from the plug-in plate, and slide to the coil hook 11. A user can connect the bundle of papers with holes to the coil 12, remove the coil 12, and put it into the binding device, to finish binding. This type of coil pressing machine has a simple structure, but its power is strong, and perfectly fits for the plug-in plate type coil. Because the coils are arranged on a plug-in plate, a coil messing up problem is avoided, which is very convenient to use: just insert the whole plug-in plate of coils into the positioning device, and then start binding.

Since the limiting board 3 can be adjusted up and down and back and forth, it meets the requirements of various coil types. The space between the limiting board 3 and the fixed board 5 is matched with the coil, so the whole plate of coils can be clamped between the limiting board 3 and the fixed board 5, and the remaining coil quantity can be monitored through the limiting board, so as to put a new plate of coils into it in time.

When the push board 1 pushes the coil 12, the plug-in plate will be securely clamped in the groove of the push board 1. The push board 1 is horizontally set, and includes a groove matching the coil positioning mechanism. Accordingly, the plug-in plate is secured in the groove of the push board 1.

The coil positioning mechanism is vertically set, so the plug-in plate type coil can be directly inserted, without other operation.

The machine casing behind the limiting board is parallel to the limiting board, and the casing includes the fixed board 5. Such a design is rather simple, without any need to separately set a fixed board; instead, the machine casing can act as the fixed board 5.

The coil pressing machine has a simple structure, and uses the plug-in plate type coil, which are widely used in the coil pressing machine field.

The above description is an optimum implementation of this invention, and the protection range of this invention is not limited to the above implementation, instead, all technical proposals belong to this invention are within the protection range. As for the technicians in this field, any modifications or trimmings related to the principle of this invention should be considered within the protection range.

What is claimed is:

1. A push ring mechanism comprising:
a push ring transmission mechanism;
a push board;
a coil positioning mechanism arranged in front of the push board, wherein a plug-in plate with coils can be inserted into the coil positioning mechanism, and a space for a coil to penetrate is arranged below the coil positioning mechanism;
the coil positioning mechanism comprises a fixed board and an adjustable limiting board, wherein a portion of the machine casing is the fixed board;
the limiting board includes a first bracket which extends through a longitudinal hole on the fixed board;
the adjustable limiting board is arranged parallel to and spaced from the fixed board, such that the plug-in plate containing coils can be inserted into the space between the limiting board and the fixed board;
a hook for holding a coil is arranged in front of the limiting board;
a limiting board adjustment mechanism is provided for adjusting the limiting board up and down and back and forth, the limiting board adjustment mechanism includes an up and down adjustment unit, a back and forth adjustment unit, and an adjustment button;
the adjustment button is fixed and connected with a gear as a transmission mechanism, and the gear is engaged with a gear rack on a second bracket to realize the up and down adjustment;
a fixed stop is included, which is set as a smooth transitional step, behind the second bracket is a gear lever, which contacts the fixed stop, when adjusted up and down, the step of the fixed stop enables the bracket to move back and forth.

2. The push ring mechanism of claim 1, the limiting board is transparent board or hollow board to enable monitoring the coil status.

3. The push ring mechanism of claim 1, wherein the push board is horizontally set and includes a groove matching the coil positioning mechanism.

4. The push ring mechanism of claim 1, wherein the coil positioning mechanism is vertically set.

5. The push ring mechanism of claim 1, wherein the push ring transmission mechanism further includes a synchronous belt, and the synchronous belt is connected with a transmission shaft, and the synchronous belt transmits the power of the transmission shaft to the push ring mechanism.

6. A coil pressing machine comprising:
a machine casing;
a push ring device;
a power device;
a transmission device; and
a binding device;
wherein the push ring device, the power device, the transmission device, and the binding device are all arranged in the machine casing;
the power device is a motor and the transmission device transmits power of the power device to the push ring device and to the binding device;
the push ring device comprises a push ring transmission mechanism and a push ring mechanism;
the push ring transmission mechanism is connected with the transmission device and the transmission device comprises a transmission shaft.
